(19) United States
(12) Patent Application Publication
(10) Pub. No.: US 2013/0129569 A1
(43) Pub. Date: May 23, 2013

(54) REACTOR, AND METHOD FOR THE GASIFICATION OF BIOMASS

(71) Applicant: Erwin Schiefer, Gnas (AT)

(72) Inventor: Erwin Schiefer, Gnas (AT)

(21) Appl. No.: 13/806,757

(22) PCT Filed: Jul. 5, 2010
(86) PCT No.: PCT/EP10/59570

§ 371 Date: Dec. 27, 2012

(30) Foreign Application Priority Data
Jul. 14, 2009 (AT) A 1102/2009

(51) Int. Cl. B01J 8/00

(52) U.S. Cl. CPC B01J 8/008
USPC 422/109; 422/232; 422/198; 422/119; 422/111; 422/225

(57) ABSTRACT

A reactor for the gasification of biomass having a reactor vessel that defines a gasification chamber with an oxidation zone, to which oxidation zone an oxygen containing gasification agent, in particular air, may be supplied from outside of the reactor vessel, wherein biomass may be continuously transported to the oxidation zone in the gasification chamber, wherein air supply elements having exit openings in the area of the oxidation zone are arranged in the reactor vessel, which extend in the transport direction of the biomass. The air supply elements are each configured in lance form and provided along at least one insulation section with an external insulation layer.

The invention relates to a reactor for the gasification of biomass having a reactor vessel that defines a gasification chamber with an oxidation zone, to which oxidation zone an oxygen containing gasification agent, in particular air, may be supplied from outside of the reactor vessel, wherein biomass may be continuously transported to the oxidation zone in the gasification chamber as well as air supply elements having exit openings in the area of the oxidation zone are arranged in the reactor vessel, which extend in the transport direction of the biomass.

The aim of the gasification of biomass is the production of generator gas (which is also designated as syngas, fuel gas or low-calorific gas). As a by-product, there are formed solid and liquid residues. Solid residues are essentially ash and the carbon that is not reacted, in the form of coke, carbon black and carbonates. Liquid residues are pyrolysis oil and condensate, which contains tars and phenols. In the gasification, the attempt is made to transfer as much of the introduced energy of the fuel, this is of the biomass, to the combustible generator gas. For this reason, in principle all non-combustible components of the gas as well as the solid and liquid residues are undesirable.

Gasification of a fuel is the thermal reaction of a solid carbon carrier with a gasification agent containing oxygen into a combustible gas. Gasification is carried out with sub-stoichiometric supply of oxygen. If air is used as a gasification agent, the gasification corresponds to a controlled combustion with lack of air. The high temperature that is necessary for the reaction in the gasification of the fuel biomass thus is the result of the reaction of the fuel with the chemically bound oxygen and the air that is supplied. Controlling the supply of combustion air, hence, has to be performed especially sensitively, as falling below the minimum amount of air will result in the end of the process, while too much air will reduce the yield of gas.

In general, in the gasification reactor there is distinguished, in accordance with the partial processes of the gasification, between four reaction zones, which are essentially defined by the temperature levels reached:
the drying zone, in which the moisture contained in the wood or the biomass, respectively, is vaporized;
the pyrolysis zone, in which there is realized the disintegration of the wood typically at temperatures between 200° C. and 500° C. and in which the volatile components are released from the biomass matrix;
the oxidation zone, in which the gasification reaction of the solid biomass and the cleavage of the hydrocarbon compounds of the pyrolysis zone are performed at temperatures between 500° C. and 2000° C.;
the reduction zone, in which the reduction of the oxidation products carbon dioxide and water is performed at glowing charcoal at average temperatures of about 500° C. and in which the fuel gas proper is formed.

From prior art there are known various embodiments of gasification reactors for biomass.

In the EP 0 565 935 A1, for example, there is shown a parallel flow gas generator having a ring-shaped fire chamber as well as a spiral-like feed screw centrally arranged therein. The spiral-like feed screw rotates about a vertical axis and is used for transporting the biogenic material to be gasified from an intermediate storage from the bottom up into the fire chamber situated above. Biogenic material, which has already passed the fire chamber but has not been completely gasified yet, hence, flows in the counter-flow from the top back to the biogenic material that is situated underneath and still to be gasified, which is then again transported from the spiral-like feed screw into the transport chamber upwards into the fire chamber. In this way, the biogenic material is moved within the fire chamber until it is completely gasified. The ring-like fire chamber has in its oxidation zone external as well as internal holes for supplying the primary combustion air.

Disadvantageous in this embodiment is that the rotating feed screw is centrally located in the fire chamber and is thus exposed to a very high thermal strain in the very hot oxidation zone. Material deformation of the spiral-like feed screw due to the prevailing high temperatures and thus being conditioned that the spiral is ground or even gets stuck at the walls of the surrounding transport chamber cannot be excluded. The herein selected process of moving the air supply in a cross-flow is further problematic. Due to the combustion air being introduced laterally in the fire chamber and thus transversally to the biomass being transported upwards, biomass, which has not been completely gasified, may disadvantageously be entrained upwards through the fire chamber into the reduction chamber, together with the ascending air stream. Incomplete gasification of the biomass and an increased production of ash are undesirable consequences thereof.

In the AT 505.188 there is shown a reactor for the gasification of biomass, wherein the biomass is moved from the top through a charging opening into the inside of the reactor. Supply of the gasification agent is therein independently from the shown embodiment variants in the transport direction of the biomass from the top downwards. The gasification agents supply elements are therefore configured as flat hollow bodies, e.g., as flat plates or as several ring-like elements each having exit openings for the gasification agent in the oxidation zone.

The disadvantage of the flat hollow bodies, which are provided in the embodiment shown in the AT 505.188 as air supply elements, is the poor coolability due to the small surface and, as a consequence, the short service life due to the strong thermal material expansion. Furthermore, the air supply is comparably poorly controllable with such air supply elements, and the space requirement thereof in regard to the free reactor volume is big.

Another embodiment variant of a gasification reactor is shown in DE 30 42 200 A 1. Therein, a gasification reactor having a reactor shaft with rectangular cross-section is introduced, which in comparison with a reactor shaft usually having a circular configuration provides for increased throughput performance. The air supply is realized in this embodiment through air nozzles that are uniformly arranged in the longitudinal walls of the shaft as well as through air supply lances that are uniformly arranged in the central area of the reactor chamber. The internal reactor chamber may be separated into several chambers by way of separation walls, which chambers may be added or switched off in order to control the throughput performance of the gasification reactor. In the reactor chamber there is provided at the lower end thereof an ash grating including a conveyor aggregate situated underneath for discharging ash.

A disadvantage of this embodiment is that the individual reaction zones having each different operational conditions may only be insufficiently adjusted and controlled in the reactor chamber above the ash grating. The oxidation zone is in this embodiment comparably small and is quickly passed by the biomass to be gasified.

In the chamber underneath the ash grating, hence, there has to be provided a possibility of supplying secondary air for the post-gasification of materials not yet combusted. The air supply lances are further arranged directly above the oxidation zone or the tips thereof are extending into the zone, respectively. The material of the air supply lances is for this reason exposed to especially high thermal strains, which entails high wear of the air supply lances.

In the operation of a solid bed reactor for the gasification of biomass it is essential to keep stable during the entire duration of the operation a reactor profile having several reaction zones that each have different operational parameters as well as to be in the position to operate the gasification reactor in adjustment to the respective raw material. In the embodiment variants described above, these requirements for an optimum operation of the gasifier cannot be met or rather only insufficiently.

Hence, it is the task of the present invention to provide a reactor for the gasification of biomass, which prevents the described disadvantages of the state of the art.

This task is solved in a processing device according to the preamble of claim 1 with the features of the characterizing part of the claim 1. The sub-claims relate to further advantageous embodiments of the invention.

Advantageously, a reactor according to the invention for the gasification of biomass having a reactor vessel that defines a gasification chamber with an oxidation zone, to which oxidation zone an oxygen containing gasification agent, in particular air, may be supplied from outside of the reactor vessel, wherein biomass may be continuously transported to the oxidation zone in the gasification chamber, comprises air supply elements in the inside of the reactor vessel, the exit openings of which are arranged in the area of the oxidation zone, which extend in the transport direction of the biomass, wherein the air supply elements are each configured in a lance form and are provided along at least one insulation section with an external insulation layer.

The externally arranged insulation layer of the insulation section is, for example, made of a fire-resistant ceramic material. This insulation layer not only protects the lance-shaped air supply element situated underneath or inside, respectively, against too much thermal strain but rather also acts as a heat accumulator, which emits the heat from the oxidation zone by way of heat radiation advantageously to the pyrolysis zone situated above, which is also designated as the pre-gasification zone. The insulation section usefully starts at the free front end of the air supply elements in the proximity of the exit openings for the gasification agent and extends along the air supply elements to the upper edge of the hot oxidation zone or to a zone of the gasification chamber with moderate reaction temperatures, respectively. The insulation sections at the lance-shaped or tubular, respectively, air supply elements, hence, have advantageously a comparably big external surface for emitting heat and simultaneously only little space requirement.

In a reactor according to the invention the air supply elements in groups are especially usefully provided with a common insulation layer along at least one insulation section. According to the respective requirements, in the construction of a gasification reactor the individual lance-shaped air supply elements may be insulated together in pairs or groups.

According to a further feature of the invention, in a reactor according to this type the air supply elements are provided along at least one heat exchange section with an external heat exchanger. This heat exchange section alongside the lance-shaped air supply elements is usefully arranged adjacently above the insulation section situated underneath. Through the external heat exchanger, the reaction temperature of the biomass in the area of the heat exchange section, which extends, for example, into the pre-gasification zone or to the drying zone situated above, respectively, may be advantageously controlled. As it is possible to use the heat exchanger also as a cooler, undesired overheating of the biomass above the oxidation zone may be prevented and, hence, a stable temperature profile may be guaranteed advantageously during the gasification in the reaction zones of the gasification reactor.

In a preferred embodiment of the invention, the air supply elements are disposed over the cross-section of the gasification chamber in a reactor.

In a useful embodiment variant of a reactor according to the invention the air supply elements are arranged in the gasification chamber in the form of a ring.

Essential in the arrangement of the air supply elements in the gasification chamber is to obtain a possibly homogenous supply of the gasification agent through the entire cross-section. The respectively lance-shaped or tubular air supply elements provide a configuration, which enables an arrangement of the air supply elements in the gasification chamber that is each individually adjusted to different reactor configurations or operational conditions.

In a reactor according to the invention the air supply elements in common or in groups are advantageously connected with a feed line. The feed line for supplying the gasification agent or the air, respectively, may, hence, be operated for each individual air supply element, or several air supply elements in groups are fed with the gasification agent via one feed line, or only one single feed line is connected with all air supply elements in a ring-like way.

In an advantageous configuration there is provided in a reactor according to the invention a device for tempering the gasification agent. The gasification agent, e.g., air, is then pre-heated in the tempering device before being blown into the gasification chamber. The tempering device is, for example, configured as a heat transmitter for pre-heating the gas, by making use of the exhaust heat of the gasification chamber for pre-heating the gasification agent.

It is further conceivable to use steam for preheating or also for admixing to the gasification agent. The device for tempering the gasification agent has usefully also a connection for the supply of steam.

In a further embodiment for solving the task according to the invention, in a reactor at least one section of the reactor wall and/or of components in the oxidation zone, in particular a section situated above the exit openings of the air supply elements, may be tempered. As already stipulated above, a shifting of the oxidation zone upwards into the pre-gasification zone or into the drying zone situated above, respectively, is to be prevented, and in the gasification reactor there is to be made provision for a stable temperature profile during the duration of the operation. For this reason, also sections of the reactor wall and/or of components in the gasification chamber are provided to be tempered.

In particular in bigger constructions of a gasification reactor according to the invention, it may be advantageous to provide additional components in the gasification chamber and to provide these also with means for tempering. As it is possible to selectively supply energy to/withdraw energy from individual sections in the gasification chamber, the reaction temperatures may be locally influenced, and, hence, the reaction course of the biomass gasification may be positively influenced or controlled, respectively.

In a reactor according to the invention, at least one section of the reactor wall and/or of components above the oxidation zone of the gasification chamber may advantageously be heated. As it is possible to supply, for example, the drying zone situated above the pre-gasification zone with external energy and to very efficiently dry the biomass, the course of the biomass gasification and the yield of produced fuel gas may be influenced appropriately positively.

In a reactor according to the invention, heat accumulation elements are usefully arranged at least at one section of the reactor wall and/or of components in the oxidation zone. Similarly to the insulation layer in the insulation section of the air supply elements, also the heat accumulation elements, which are arranged section-wise at the reactor wall and/or components in the oxidation zone, will transmit radiation heat from the oxidation zone to the pre-gasification zone situated adjacently above. The course of the temperature profile inside of the gasification chamber is thereby made more consistent.

Especially advantageously there is provided in a reactor according to the invention, above the oxidation zone, at least one sensor for monitoring the temperature. By positioning a temperature sensor above the oxidation zone, the respective energy release rate or exit gas velocity, respectively, of the used biogenic materials is quickly determined.

In an alternative embodiment, there is provided in a reactor according to the invention at the exit of the tempering medium at least one sensor for monitoring the temperature. The return temperature of the tempering medium, which flows through the heat exchangers of the heat exchange sections along the air supply elements and/or through the heat exchangers along the tempering sections at the reactor wall and/or through the heat exchangers at the components in the inside of the gasification chamber, is monitored by its own temperature sensor.

Also combinations of at least one temperature sensor, which is arranged approximately above the oxidation zone in the inside of the gasification chamber, with at least one temperature sensor, which monitors the return temperature and/or the flow temperature of the tempering medium, are conceivable and comprised by the invention.

In a reactor according to the invention a control unit usefully controls the device for the tempering of the gasification agent and/or the tempering of the heat exchangers of the air supply elements and/or the tempering section of the reactor wall and/or of the tempering section of components within the gasification chamber above the oxidation zone and/or the ratio between the gasification agent supplied thereto and the supply air and/or the supply of steam the by way of the signals of a sensor for monitoring the temperature.

For this reason, the control unit is usefully connected with the at least one temperature sensor by means of control lines. The signals of the temperature sensor are registered by the control unit and then evaluated, serving for controlling at least one of the following devices:
the device for tempering the gasification agent, in which the gasification or the air, respectively, may be pre-heated;
the tempering of the heat exchangers along the heat exchange sections of the air supply elements;
the tempering of the tempering section at the reactor wall;
the tempering of the tempering section at components within the gasification chamber;
the ratio between the gasification agent supplied thereto and the supply air, which enters the gasification chamber together with the biomass supplied thereto;
the supply of steam, which may, for example, be admixed to the gasification agent.

In particular the air ratio between the gasification agent that is directly blown in and the air directly blown in to the supply air that flows in with the biomass into the oxidation zone is essential for the control of the gasification reaction and/or for the adjustment of the course of the upper limit of the oxidation zone.

In another development of the device according to the invention a reactor has a distributor device for biomass, comprising a vessel having at least one opening arranged eccentrically at the lower section thereof, wherein the vessel in the gasification chamber is arranged to be movable and freely rotatable at a drive shaft. The distributor device is usefully provided at the upper section of the gasification chamber. The biomass enters through a filling shaft due to gravity the inside of the gasification chamber and moves from the top downwards into the vessel. By the rotational movement of the rotating vessel, the biomass is radially moved to the outside and exits the vessel through one or several openings, which are eccentrically provided, for example, in the bottom or in a lower section of the vessel, and reaches the drying zone in the upper section of the gasification chamber.

In a reactor according to the invention, the drive shaft of the vessel is usefully directed from outside of the reactor vessel into the gasification chamber in a vertically standing position.

In an especially advantageous embodiment, in a reactor of this type the drive shaft is coupled in motion with its own drive.

In another advantageous embodiment of a reactor according to the invention an agitator is arranged at the distributor device at the bottom side of the vessel. By the agitator, which is situated at the bottom side of the vessel, the biomass is uniformly distributed in the gasification chamber, and the undesired formation of cones or ridges and/or the blocking of the biomass supplied is prevented in the gasification reactor. The drying performance and, as a consequence, the gasification performance of the biomass are thus essentially improved.

Further features of the invention become apparent by the following description of exemplary embodiments and in reference to the drawing.

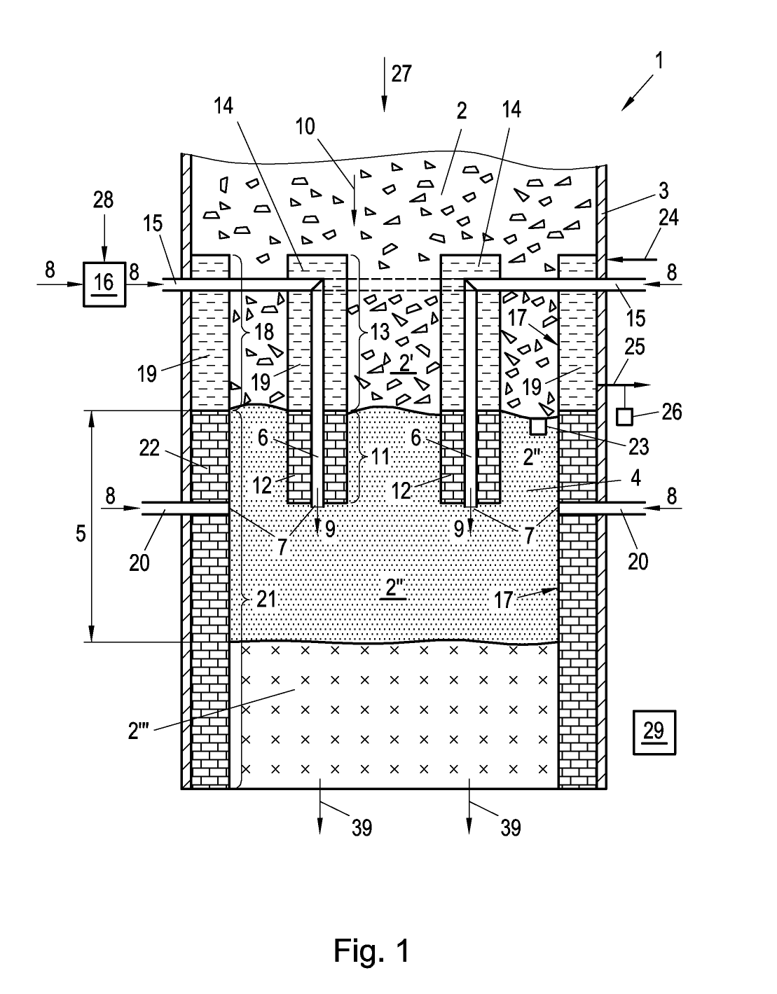

FIG. 1 shows in a schematic drawing from the side a detail of a reactor according to the invention for the gasification of biomass.

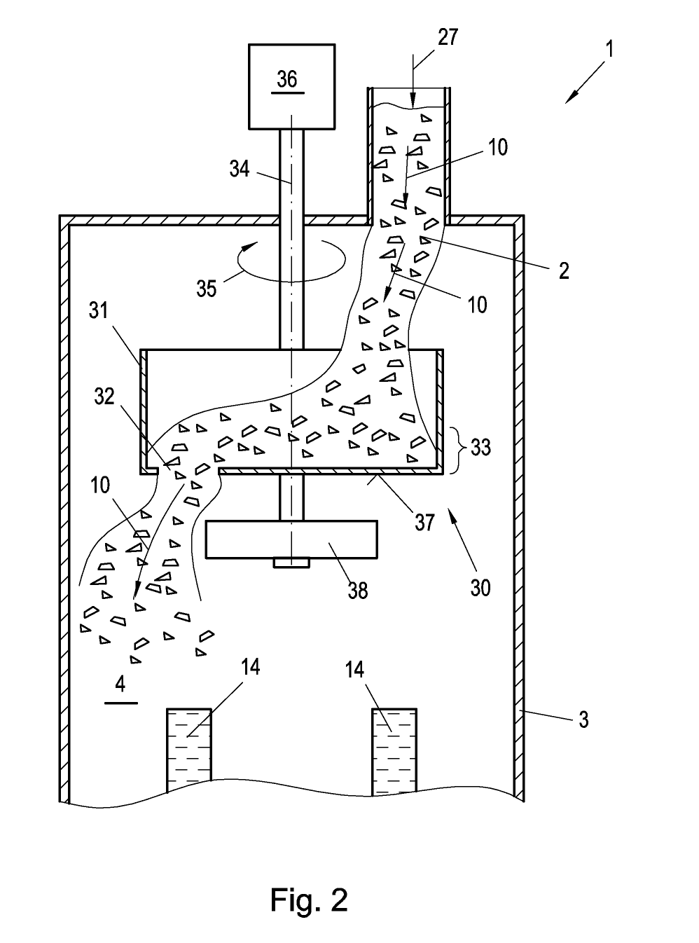

FIG. 2 shows in a very simplified illustration a distributor device for biomass according to the invention.

In FIG. 1 there is depicted a reactor 1 according to the invention for the gasification of biomass 2. The reactor 1 comprises a reactor vessel 3 having a gasification chamber 4, which is situated within the reactor vessel 3. The biomass 2 moves from the top, for example, through a filling shaft not depicted in detail into the gasification chamber 4 and reaches the oxidation zone 5 of the reactor 1 following a certain retention time after passing the drying zone or the pre-gasification zone, respectively. Several lance-shaped air supply elements 6, which each have at their lower free end exit openings 7 for the supply of a gasification agent 8 into the oxidation zone 5, lead into the oxidation zone 5. Herein, air 8 is supplied as gasification agent 8 in the direction of the arrow 9 of the oxidation zone 5. The lance-shaped or tubular, respectively, air supply elements 6 are arranged in the transport direction 10 of the biomass 2. The discharge direction 9 of the air 8 from the exit openings 7 of the air supply elements 6, hence, corresponds to the transport direction 10 of the biomass 2.

If required, there may also be attached gasification agent distribution devices at the exit openings 7, which cause an especially uniform distribution of the gasification agent in the oxidation zone. These gasification agent distribution devices are not illustrated in FIG. 1.

Starting at the lower free ends in the proximity of the exit openings 7 of each air supply element 6 there is provided along an insulation section 11, which extends in the respective longitudinal direction of the air supply elements 6, an external insulation layer 12, which is, for example, made of a fire-resistant ceramic material. The insulation section 11 during operation extends to the upper edge of the oxidation zone 5. Adjacently above thereto, a heat exchange section 13 having a heat exchanger 14, which is respectively arranged at the air supply elements 6, extends along the length of each air supply element 6.

As depicted in FIG. 1, the air supply elements 6 are distributed evenly across the cross-section of the gasification chamber 4, and they are connected via a common feed line 15 for supplying air 8. The feed line 15 is provided with a tempering device 16 for pre-heating the air 8. There is also provided the possibility of a steam supply 28 for admixture to the air 8 in the tempering device 16.

Also in the area of the reactor wall 17 there is provided a circumferential tempering section 18, which comprises, e.g., a heat exchanger 14 having a tempering medium 19 situated therein. The tempering section 18 is positioned above the oxidation zone 5 of the reactor 1. The reactor wall 17 is provided, approximately at the height of the exit openings 7 of the air supply elements 6, with several secondary air supply elements 20, which introduce air 8 into the oxidation zone 5 in addition to the lance-shaped air supply elements 6.

Additional components in the gasification chamber 4 above the oxidation zone 5, which are also provided, for example, with a tempering section comprising a heat exchanger with a tempering medium situated therein, are not illustrated in FIG. 1. In particular in the case of bigger configurations of a gasification reactor 1 of this type, it is possible to significantly enlarge the heat transmission area of the tempering section by such additional components and, hence, the control of the temperature management in the various reaction zones of the reactor 1 may be further improved.

In the oxidation zone 5 and the reduction zone adjacently underneath, the reactor wall 17 is provided with several heat accumulation elements 22 forming a heat accumulation section 21. The heat accumulation elements 22 are made of a heat-resistant ceramic material, such as the insulation layer 12 of the air supply elements 6.

A temperature sensor 23 is arranged at the upper end of the oxidation zone 5, which detects a temperature change within the gasification chamber 4 or at the upper end of the oxidation zone 5, respectively, and which transfers the measurement data to a control unit 29. In addition, there is provided in the embodiment illustrated in FIG. 1 also in the circulation line of the tempering medium 19 at the exit side 25 of the heat exchanger 14 a temperature sensor 26, which detects a change of the return temperature of the tempering medium 19 or a change of the temperature difference between the flow temperature at the entry 24 of the tempering medium 19 and the return temperature at the exit 25 of the tempering medium 19.

The control lines between the control unit 29 and the temperature sensors 23 or 26, respectively, are not illustrated in FIG. 1 for reasons of a better understanding thereof.

At the top side of the reactor 1, also supply air 27 reaches the oxidation zone 5 through the filling shaft together with the biomass 2 supplied. The proportion between the air 8 supplied by the air supply elements 6 or the secondary air supply elements 20, respectively, and the supply air 27 constitutes an essential operational parameter for controlling the gasification reaction. On the basis of the measurement data of the temperature sensors 23 or 26, respectively, the control units 29 also controls the proportion between the air 8 supplied and the supply air 27. If need be, the flow meters, flaps, fans, frequency converters or valves required for controlling the proportion between air 8 and supply air 27 in the individual feed lines as well as the respective control lines from the fittings to the control unit 29 are not depicted in FIG. 1 for the sake of clarity.

The biomass 2, for example, wooden chips, changes during its retention time in the gasification reactor 1 in regard to its composition as well as its state of aggregation. Shortly after entry of the biomass 2 in the gasification chamber 4 in the direction of arrow 10, there is performed in the drying section the evaporation of the water contained in the wood. The developing water steam is then converted in the subsequent reaction zones situated underneath.

In the subsequent pyrolysis zone, the then already dried biomass 2′ is then disintegrated by way of adding air to the biomass bulk. At temperatures of up to 500° C., there are formed the already mentioned disintegration products carbonization gas, hydrocarbon in the form of carbon and condensate. Thereby, also the macromolecular ingredients of the wood dried in the drying zone, e.g., cellulose as well as lignin, are then thermally disintegrated.

The remaining biomass 2″, which further reaches the oxidation zone 5, consists essentially already of gaseous, volatile components of the wood. As a solid there is essentially present only carbon in the form of charcoal.

In the subsequent reduction zone, the biomass 2′″, essentially carbon dioxide and water, is reduced at the glowing charcoal, and there are formed carbon monoxide, hydrogen and methane as components of the fuel gas 39 to be produced. The fuel gas 39 leaves the reactor 1 in the lower section of the reactor vessel 3; it may be, if required, transported to post-treatment devices and/or cleaning devices, and is then available as generator gas.

In FIG. 2, a distributor device 30 according to the invention for the distribution of biomass 2 is shown in a schematic sectional view. This distributor device 30 is arranged at the upper end of the reactor vessel 3 within the gasification chamber 4. A vessel 31 that is open at its top side, for example, having a circular bottom and several eccentrically arranged openings 32, which are arranged in a lower section 33 or in the bottom of the vessel 31, respectively, and that is further provided with a circumferential lateral wall is attached at a rotatable drive shaft 34. The drive shaft 34 rotates in the direction of the arrow 35 and is coupled in motion with its own drive 36.

Also other configurations of the vessel 31 are conceivable. For example, the vessel 31 may also be configured in a funnel- or cone-like, respectively, form, wherein in the proximity of the tip of the funnel that is open on top, this is the deepest point of the vessel 31, there is provided an eccentrically arranged opening 32. This embodiment variant is not illustrated.

By the rotational movement of the vessel 31, the biomass 2, which enters the gasification reactor 1 through a filling shaft from the outside and the vessel 31 from the top in the transport direction 10, is transported radially to the outside and leaves through the openings 32. At the bottom side 37 of the vessel 31, there is attached an agitator 38 at the drive shaft 34, which agitator rotates along with the vessel 31. A uniform distribution of the biomass 2 charged is obtained within the gasification chamber 4 by the agitator 38, thus increasing the drying rate of the biomass 2. The efficiency of the gasification reactor 1 according to the invention as well as the gas quality of the fuel gas 39 produced are, hence, improved. By way of the more homogenous bulk of the biomass 2 in the drying zone, all reaction zones in the reactor may be better regulated, and the gasification process is realized more stably and uniformly.

The agitator 38 may usefully be attached also directly at the bottom side 37 or at the lower section 33 of the rotating vessel 31, respectively. According to the type of the reactor 1 or depending on the nature of the biomass 10 to be gasified, respectively, there are conceivable different embodiment forms of the agitator 38. The agitator 38, for example, may be embodied as blade or paddle agitator, as a rake-like grid or as a curved tube.

At least one agitator 38 may usefully further be provided with its own drive, which is independent of the drive 36 of the vessel 31. There are also conceivable variants having several agitators 38, which are arranged across the cross-section of the gasification chamber 4 independent of the vessel 31 and which guarantee also an especially uniform distribution of the biomass 10 charged.

### List of Position Numbers

1 reactor

2 biomass

3 reactor vessel

4 gasification chamber

5 oxidation zone

6 air supply elements

7 exit openings of the air supply elements 6

8 air or gasification agent, resp. (supply in direction of arrow)

9 exit direction of the gasification agent 9 (in direction of the arrow)

10 transport direction of the biomass 2 (in direction of the arrow)

11 insulation section of the air supply element 6

12 insulation layer of the air supply element 6

13 heat exchange section

14 heat exchanger

15 feed line

16 tempering device for the gasification agent 8

17 reactor wall

18 tempering section of the reactor wall 17

19 tempering medium

20 secondary air supply elements

21 heat accumulation section

22 heat accumulation element

23 temperature sensor in the gasification chamber

24 entry of the tempering medium 19 (in direction of arrow)

25 exit of the tempering medium 19 (in direction of arrow)

26 temperature sensor for tempering medium 19

27 supply air (supply in direction of arrow)

28 steam supply (in direction of arrow)

29 control unit

30 distributor facility

31 vessel

32 opening

33 lower section of the vessel 31

34 drive shaft

35 direction of rotation of the vessel 31 (direction of arrow)

36 drive

37 bottom side of the vessel 31

38 agitator

39 fuel gas

1. A reactor for the gasification of biomass having a reactor vessel that defines a gasification chamber with an oxidation zone, to which oxidation zone an oxygen containing gasification agent, in particular air, may be supplied from outside of the reactor vessel, wherein biomass may be continuously transported to the oxidation zone in the gasification chamber as well as air supply elements having exit openings in the area of the oxidation zone are arranged in the reactor vessel, which extend in the transport direction of the biomass, wherein the air supply elements are each configured in lance form and provided along at least one insulation section with an external insulation layer.

2. A reactor according to claim 1, wherein the air supply elements are provided in groups with a common insulation layer along at least one insulation section (11).

3. A reactor according to claim 1, wherein the air supply elements are provided along at least one heat exchange section with an external heat exchanger.

4. A reactor according to claim 1, wherein the air supply elements are arranged over the cross-section of the gasification chamber.

5. A reactor according to claim 1, wherein the air supply elements are arranged ring-like in the gasification chamber.

6. A reactor according to claim 1, wherein the air supply elements are connected in common or in groups with a feed line.

7. A reactor according to claim 1, wherein there is provided a device for tempering the gasification agent.

8. A reactor according to claim 1, wherein there may be tempered at least one section of the reactor wall and/or of components in the oxidation zone, in particular a section situated above the exit openings of the air supply elements.

9. A reactor according to claim 1, wherein at least one section of the reactor wall and/or of components above the oxidation zone of the gasification chamber may be heated.

10. A reactor according to claim 1, wherein there are arranged heat accumulation elements at least at one section of the reactor wall and/or of components in the oxidation zone.

11. A reactor according to any of 1, wherein there is provided above the oxidation zone at least one sensor for monitoring the temperature.

12. A reactor according to claim 1, wherein there is provided at the exit of the tempering medium at least one sensor for monitoring the temperature.

13. A reactor according to claim 11, wherein a control unit controls the device for tempering the gasification agent- and/or the tempering of the heat exchangers of the air supply elements and/or of the tempering section of the reactor wall and/or of components within the gasification chamber above the oxidation zone and/or the ratio between the gasification agent supplied thereto and the supply air and/or the supply of steam by way of the signals of the sensor for monitoring the temperature.

14. A reactor according to claim 1, wherein a distributor device for biomass comprises a vessel having at least one opening arranged eccentrically at its lower section, wherein the vessel is arranged freely rotatable at a drive shaft in the gasification chamber.

15. A reactor according to claim 14, wherein the drive shaft of the vessel is directed from outside of the reactor vessel into the gasification chamber in a vertically standing position.

16. A reactor according to claim 14, wherein the drive shaft is coupled in motion with its own drive.

17. A reactor according to claim 14, wherein there is arranged an agitator at the distributor device at the bottom side of the vessel.
